(19) United States
(12) Patent Application Publication
(10) Pub. No.: US 2026/0194205 A1
(43) Pub. Date: Jul. 9, 2026

(54) Lamp

(71) Applicants: ETI SOLID STATE LIGHTING INC, Wheeling, IL (US); CRAWFORD GLOBAL LIMITED, Hong Kong (CN)

(72) Inventor: Donglei WANG, Zhuhai, Guangdong (CN)

(21) Appl. No.: 18/276,896

(22) PCT Filed: Jul. 25, 2023
(86) PCT No.: PCT/CN2023/109180

§ 371 Date: Aug. 11, 2023

(51) Int. Cl. F21V 7/00; F21Y 103/10

(52) U.S. Cl. CPC F21V 7/0008; F21V 7/005; F21Y 2103/10

(57) ABSTRACT

The disclosure provides a lamp. The lamp includes a lamp body and a light source. The lamp body is provided with a reflective structure, the reflective structure is provided with a reflective cavity, and two ends of the reflective cavity are provided with a top light outlet and a bottom light outlet, respectively. The light source is arranged in the reflective cavity and spaced from an inner wall of the reflective structure, and at least part of light of the light source is emitted toward an inner wall surface of the reflective structure. The inner wall surface of the reflective structure is configured to reflect the light, such that the light is emitted from the top light outlet and the bottom light outlet, and at least one of the light source and the reflective structure is movably arranged, such that a luminous flux is adjustable.

### TECHNICAL FIELD

The disclosure relates to the technical field related to illumination devices, and particularly relates to a lamp.

### BACKGROUND

Lamps were created to satisfy daily illumination demand of life and work. Typically, lamps on the current market are divided into a direct-down type, an indirect type and a direct-down+indirect type in terms of light emitting directions. The three types correspond to three lamps having different structures, respectively.

Similar to lamps in the prior art, any of the above lamps emits light in a single direction. Generally, its housing wall is independent of its internal reflective structure and is neither rotatable nor changeable in shape. Therefore, a lamp body and an optical system are combined in a single way, and the lamp cannot be adjusted according to needs of application scenarios of users, resulting in poor user experience.

In conclusion, an existing lamp has a single light output direction and cannot be adjusted according to needs of application scenarios of users.

### SUMMARY

A main objective of the disclosure is to provide a lamp, so as to solve the problem that a lamp in the prior art has a single light output direction and cannot be adjusted according to needs of application scenarios of users.

In order to achieve the above objective, an embodiment of the disclosure provides a lamp. The lamp includes a lamp body, where the lamp body is provided with a reflective structure, the reflective structure is provided with a reflective cavity, and two ends of the reflective cavity are provided with a top light outlet and a bottom light outlet, respectively; and a light source, where the light source is arranged in the reflective cavity and spaced from an inner wall of the reflective structure, and at least part of light of the light source is emitted toward an inner wall surface of the reflective structure; and the inner wall surface of the reflective structure is configured to reflect the light, such that the light is emitted from the top light outlet and the bottom light outlet, and at least one of the light source and the reflective structure is movably arranged, such that a luminous flux of the top light outlet and the bottom light outlet is adjustable.

In an embodiment mode, a light output direction of the light source and an opening direction of the bottom light outlet are arranged with an included angle therebetween, such that the light source does not directly irradiate the bottom light outlet. Or, a light output direction of the light source and an opening direction of the top light outlet are arranged with an included angle therebetween, such that the light source does not directly irradiate the top light outlet.

In an embodiment mode, the included angle between the light output direction of the light source and the opening direction of the bottom light outlet is greater than 90° and smaller than 270°; and/or light emitted from the bottom light outlet is reflected by the reflective structure and the reflective cavity and then emitted.

In an embodiment mode, in a direction of the top light outlet and the bottom light outlet, a distance between the light source and the top light outlet is greater than that between the light source and the bottom light outlet; or, a distance between the light source and the top light outlet is smaller than that between the light source and the bottom light outlet.

In an embodiment mode, the reflective structure includes two reflective plates arranged oppositely, and the reflective cavity is formed between the two reflective plates. The number of the light source is one. Or, the number of the light sources is multiple, the light sources are arranged corresponding to the different reflective plates, and heat dissipation gaps are formed between the light sources and the adjacent reflective plates.

In an embodiment mode, the reflective structure includes two reflective plates arranged oppositely, surfaces facing each other of the two reflective plates are reflective surfaces, the light source is movably arranged between the two reflective plates, and at least part of the light of the light source is emitted toward the reflective surfaces. The lamp body further includes end covers arranged oppositely, where the reflective plates are connected to the end covers, the reflective plates and the end covers match each other to define the reflective cavity, and the end covers are configured to be connected to mounting positions.

In an embodiment mode, the light source is removably and/or rotatably arranged on the end covers; and/or the reflective plates are removably and/or rotatably arranged on the end covers.

In an embodiment mode, the reflective structure further includes a reflective cover arranged in the reflective cavity, a light output end of the light source faces the reflective cover, and at least a surface facing the light source of the reflective cover is a light reflecting surface. In a direction of the top light outlet and the bottom light outlet, the reflective cover is located between the light source and the top light outlet. Or, in a direction of the top light outlet and the bottom light outlet, the reflective cover is located between the light source and the bottom light outlet.

In an embodiment mode, an outer surface of the reflective cover is formed by sequentially connecting a plurality of light reflecting surfaces. The light reflecting surfaces facing the light source are configured to guide light in the reflective cavity to the reflective plates and/or the top light outlet and/or the bottom light outlet.

In an embodiment mode, at least one end surface of the light reflecting surface is a flat surface; and/or at least one end surface of the light reflecting surface is an arc-shaped surface.

In an embodiment mode, the outer surface of the reflective cover includes a first arc-shaped section, a second arc-shaped section and a third arc-shaped section that are sequentially connected end to end. Two of the first arc-shaped section, the second arc-shaped section and the third arc-shaped section are concave arcs, and the other arc-shaped section is a convex arc. The two concave arcs are arranged symmetrically with respect to the convex arc. Or, the two concave arcs have different radii of curvature.

In an embodiment mode, the reflective cover is fixedly mounted on the end covers of the lamp body. Or, the reflective cover is removably and/or rotatably arranged on the end covers of the lamp body.

In an embodiment mode, the lamp further includes two groups of transmission assemblies. The light source is removably and/or rotatably connected to the end covers of the lamp body by means of the transmission assemblies; and/or the reflective cover is removably and/or rotatably connected to the end covers of the lamp body by means of the transmission assemblies; and/or the reflective plates are removably and/or rotatably connected to the end covers of the lamp body by means of the transmission assemblies.

In an embodiment mode, the transmission assembly includes one group of movable members, the one group of the movable members includes two movable members arranged in a pair or is an integrated movable member, the movable member is movably connected to the end covers, and the light source or the reflective cover is mounted on the movable member. Or, the transmission assembly includes two groups of movable members, each group of the movable members includes two movable members arranged in a pair or is an integrated movable member, the movable members are movably connected to the end covers, the light source is mounted on one group of the movable members, and the reflective cover is mounted on the other group of the movable members. Or, the transmission assembly includes two groups of movable members, each group of the movable members includes two movable members arranged in a pair or is an integrated movable member, each group of the movable members are connected to the two end covers separately, and the two reflective plates are mounted on the two groups of the movable members. Or, the transmission assembly includes three groups of movable members, each group of the movable members includes two movable members arranged in a pair or is an integrated movable member, each group of the movable members are movably connected to the end covers, the light source or the reflective cover is mounted on one group of the movable members, and the two reflective plates are mounted on the other two groups of the movable members, respectively. Or, the transmission assembly includes four groups of movable members, each group of the movable members includes two movable members arranged in a pair or is an integrated movable member, each group of the movable members are movably connected to the end covers, the light source is mounted on one group of the movable members, the reflective cover is mounted on another group of the movable members, and the two reflective plates are mounted on the other two groups of the movable members, respectively.

In an embodiment mode, the end covers of the lamp body are provided with slots, and at least part of the transmission assembly is removably arranged in the slots. The slots extend in a direction in which the two reflective plates face each other; and/or the slots extend in the direction of the top light outlet and the bottom light outlet; and/or the slots extend in a direction with an angle formed between which and a direction in which the two reflective plates face each other.

In an embodiment mode, the end covers of the lamp body are provided with slots, and at least part of the transmission assembly is removably arranged in the slots. The slots extend in a direction in which the two reflective plates face each other, such that the reflective cover and the light source are aligned or staggered in the direction of the top light outlet and the bottom light outlet; and/or the slots extend in the direction of the top light outlet and the bottom light outlet, such that a distance between the reflective cover and the light source in the direction of the top light outlet and the bottom light outlet increases or decreases; and/or the slots extend in a direction with an angle formed between which and a direction in which the two reflective plates face each other, such that the reflective cover and the light source are aligned or staggered in the direction of the top light outlet and the bottom light outlet, and/or a distance between the reflective cover and the light source in the direction of the top light outlet and the bottom light outlet increases or decreases.

In an embodiment mode, the end covers of the lamp body are provided with slots. The transmission assembly further includes moving members, where at least part of an end of the movable member penetrates the slot so as to be connected to the moving member, and the moving member is located on an outer side of the reflective cavity; and driving members, where the driving members are mounted on the end covers, and the driving members are in driving connection with the moving members.

In an embodiment mode, the moving members are racks, the driving members are electric motors, output ends of the electric motors are provided with gears, and the gears mesh with the racks. Or, the moving members are racks, the driving members are handle assemblies, the handle assemblies include gears and rotary discs, the gears are rotatably mounted on the end covers and mesh with the racks, the rotary discs are fixedly connected to the gears, and the rotary discs are in driving connection with the racks by means of the gears.

In an embodiment mode, the end covers of the lamp body are provided with slots. One group of opposite inner wall surfaces of the slot are provided with a plurality of groups of clamping grooves corresponding to each other in position. The clamping grooves are in communication with the slots. The plurality of groups of clamping grooves are provided at intervals in an extension direction of the slot. The transmission assembly further includes moving members, where at least part of an end of the movable member penetrates the slot so as to be connected to the moving member, and the moving member is located on an outer side of the reflective cavity; and sleeves, where the moving members are connected to the sleeves, bottom surfaces of the sleeves are provided with elastic clamping arms, the elastic clamping arms are accommodated in the slots, or, at least part of the elastic clamping arm extends into the clamping groove.

In an embodiment mode, the end of the movable member is rotatably connected to the moving member. The moving member is provided with a mounting hole. An inner wall surface of the mounting hole is provided with a plurality of groove structures. An outer peripheral surface of the end of the movable member is provided with at least one protrusion. The protrusion matches the groove structures in a clamped manner.

In an embodiment mode, the surfaces facing each other of the two reflective plates arranged in a pair are flat surfaces or curved surfaces; and/or surfaces away from each other of the two reflective plates arranged in a pair are flat surfaces or curved surfaces; and/or the reflective plates are made of a transparent material or a semitransparent material; and/or the surfaces facing each other of the two reflective plates arranged in a pair are covered with reflective films or reflective paint or reflective powder.

In an embodiment mode, the light source is a linear light source; and/or the lamp is a long-strip lamp; and/or the lamp is a ceiling lamp.

According to the technical solution of the disclosure, the lamp includes the lamp body and the light source, where the lamp body is provided with the reflective structure, the reflective structure is provided with the reflective cavity, and the two ends of the reflective cavity are provided with the top light outlet and the bottom light outlet, respectively; the light source is arranged in the reflective cavity and spaced from the inner wall of the reflective structure, and at least part of the light of the light source is emitted toward the inner wall surface of the reflective structure; and the inner wall surface of the reflective structure is configured to reflect the light, such that the light is emitted from the top light outlet and the bottom light outlet, and at least one of the light source and the reflective structure is movably arranged, such that the luminous flux of the top light outlet and the bottom light outlet is adjustable.

In view of the above description, the reflective structure of the lamp of the disclosure is provided with double light outlets including the top light outlet and the bottom light outlet, such that the light output direction is increased. In addition, at least one of the light source and the reflective structure of the disclosure is movably arranged, such that a light output path of the light is adjusted by adjusting the light source and the reflective structure. Further, the luminous flux of the top light outlet and the bottom light outlet is adjustable, such that output light is adjusted according to needs of use scenarios, and user experience is improved.

### BRIEF DESCRIPTION OF THE DRAWINGS

The accompanying drawings constituting a part of the disclosure serve to provide further understanding of the disclosure, and illustrative embodiments of the disclosure and the description of the illustrative embodiments serve to explain the disclosure and are not to be construed as unduly limiting the disclosure. In the accompanying drawings:

FIG. 1 shows a schematic diagram of a solid structure of a lamp of the disclosure;

FIG. 2 shows a schematic diagram of a mounting structure of a light source in Embodiment 1 of the disclosure;

FIG. 3 shows a schematic diagram of another mounting structure of the light source in Embodiment 1 of the disclosure;

FIG. 4 shows a schematic diagram of a mounting structure of a plurality of light sources in Embodiment 1 of the disclosure;

FIG. 5 shows a schematic diagram of a mounting structure of a light source in Embodiment 2 of the disclosure;

FIG. 6 shows a schematic diagram of another mounting structure of the light source in Embodiment 2 of the disclosure;

FIG. 7 shows a schematic diagram of an internal mounting structure of a light source in Embodiment 3 of the disclosure;

FIG. 8 shows a schematic diagram of a solid mounting structure of the light source in Embodiment 3 of the disclosure;

FIG. 9 shows a schematic diagram of a mounting structure of a light source in Embodiment 4 of the disclosure;

FIG. 10 shows a schematic diagram of an internal structure of a reflective plate in Embodiment 5 of the disclosure;

FIG. 11 shows a schematic diagram of a mounting structure of the reflective plate in Embodiment 5 of the disclosure;

FIG. 12 shows a schematic diagram of a mounting structure of the other reflective plate in Embodiment 5 of the disclosure;

FIG. 13 shows a schematic diagram of a mounting structure of the other reflective plate in Embodiment 5 of the disclosure;

FIG. 14 shows a schematic diagram of a mounting structure of the other reflective plate in Embodiment 5 of the disclosure;

FIG. 15 shows a schematic diagram of a mounting structure of the other reflective plate in Embodiment 5 of the disclosure;

FIG. 16 shows a schematic diagram of a mounting structure of a reflective cover in Embodiment 7 of the disclosure;

FIG. 17 shows another schematic diagram of a mounting structure of the reflective cover in Embodiment 7 of the disclosure;

FIG. 18 shows yet another schematic diagram of a mounting structure of the reflective cover in Embodiment 7 of the disclosure;

FIG. 19 shows still another schematic diagram of a mounting structure of the reflective cover in Embodiment 7 of the disclosure;

FIG. 21 shows a schematic diagram of a mounting structure of a reflective cover in Embodiment 8 of the disclosure;

FIG. 22 shows a schematic diagram of a mounting structure of a reflective cover in Embodiment 9 of the disclosure;

FIG. 23 shows a schematic diagram of an adjustable structure of a reflective plate of the disclosure, where each end cover is provided with two fixing shafts; and

FIG. 24 shows a schematic diagram of an adjustable structure of a reflective plate of the disclosure, where each end cover is provided with a fixing shaft.

The above figures involve the following reference numerals:
10, lamp body; 101, top light outlet; 102, bottom light outlet; 103, reflective cavity; 1031, heat dissipation gap; 110, reflective plate; 120, end cover; 1201, slot; 1202, clamping groove; 20, light source; 30, reflective cover; 310, first arc-shaped section; 320, second arc-shaped section; 330, third arc-shaped section; 40, transmission assembly; 410, driving member; 420, moving member; 50, lifting rope; 60, handle assembly; 70, sleeve; 80, elastic clamping arm.

### DETAILED DESCRIPTION OF THE EMBODIMENTS

It should be noted that embodiments in the disclosure and features in the embodiments can be combined with one another if there is no conflict. The disclosure will be described in details below with reference to the drawings and in combination with the embodiments.

It should be noted that all technical and scientific terms used in the disclosure have the same meanings as commonly understood by those of ordinary skill in the art to which the disclosure belongs unless otherwise indicated.

In the disclosure, unless otherwise stated, the orientation words such as “upper”, “lower”, “top” and “bottom” are generally used for directions shown in the drawings, or for components that are in a vertical direction, a perpendicular direction or a gravity direction; and similarly, for convenience of understanding and description, “inside” or “outside” refers to inside or outside relative to an outline of each component itself, but the above orientation words are not used to limit the disclosure.

In order to solve the problem that a lamp in the prior art has a single light output direction and cannot be adjusted according to needs of application scenarios of users, the disclosure provides a lamp. The lamp is a ceiling lamp, a long-strip lamp, etc.

### Embodiment 1

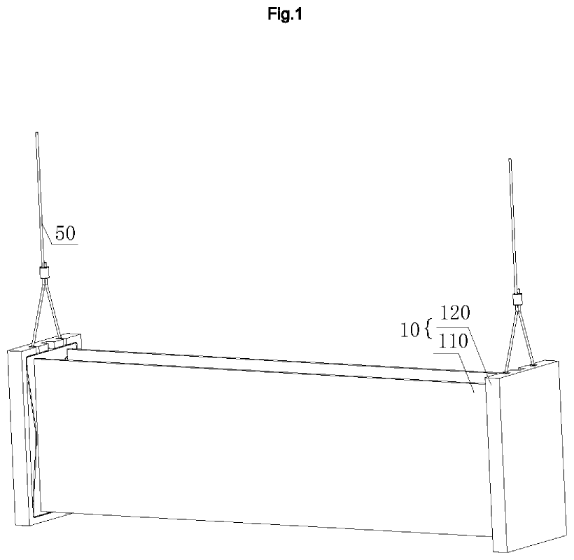

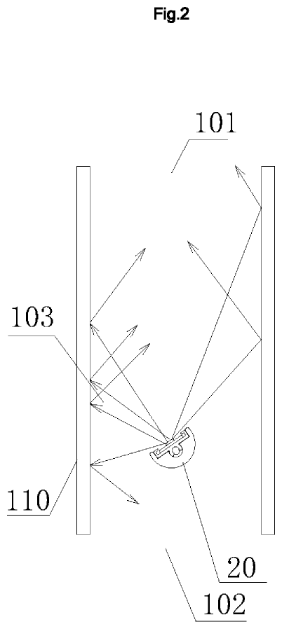

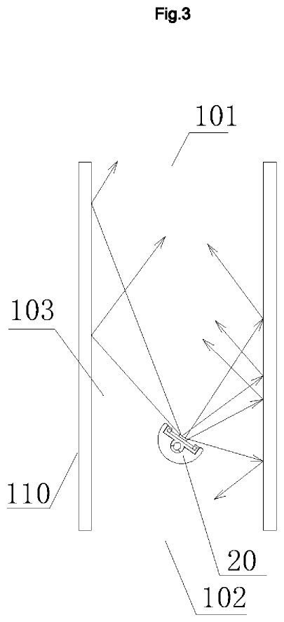

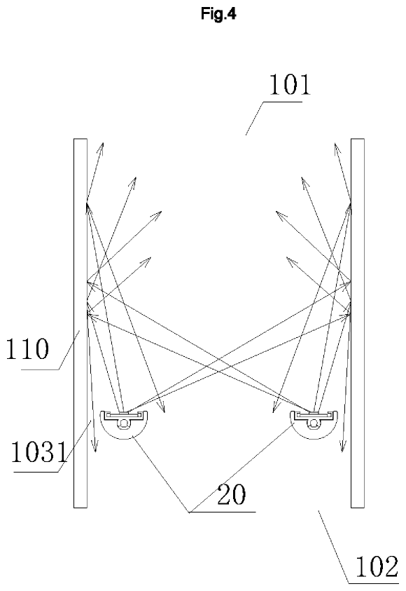

As shown in FIGS. 1-4, the lamp includes a lamp body 10 and a light source 20. The lamp body 10 is provided with a reflective structure, the reflective structure is provided with a reflective cavity 103, and two ends of the reflective cavity 103 are provided with a top light outlet 101 and a bottom light outlet 102, respectively. The light source 20 is arranged in the reflective cavity 103 and spaced from an inner wall of the reflective structure, and at least part of light of the light source 20 is emitted toward an inner wall surface of the reflective structure. The inner wall surface of the reflective structure is configured to reflect the light, such that the light is emitted from the top light outlet 101 and the bottom light outlet 102, and the light source 20 is movably arranged, such that a luminous flux of the top light outlet 101 and the bottom light outlet 102 is adjustable.

Specifically, the reflective structure of the lamp of the disclosure is provided with double light outlets including the top light outlet 101 and the bottom light outlet 102, such that a light output direction is increased. In addition, the light source 20 of the disclosure is movably arranged, such that a light output path of the light is adjusted by adjusting the light source 20 and the reflective structure. In an embodiment mode, the luminous flux of the top light outlet 101 and the bottom light outlet 102 is adjustable, such that output light is adjusted according to needs of use scenarios, and user experience may be improved.

In an embodiment mode, the light source 20 is rotatably arranged in the reflective cavity 103, and a light emitting direction of the light source 20 is adjusted through rotation. The light emitted from the light source 20 is emitted toward the inner wall surface of the reflective structure, and then guided to the top light outlet 101 and the bottom light outlet 102 under the reflection of the inner wall surface of the reflective structure. In an embodiment mode, the luminous flux of the top light outlet 101 and the bottom light outlet 102 is changed.

In the present embodiment, the reflective structure includes two reflective plates 110 arranged oppositely, the reflective cavity 103 is formed between the two reflective plates 110, and surfaces facing each other of the two reflective plates 110 are reflective surfaces. The light source 20 is rotatably arranged between the two reflective plates 110, and emits the light toward the reflective surfaces. The reflective surfaces are configured to reflect the light and then guide the light to the top light outlet 101 and the bottom light outlet 102.

It should be noted that the lamp of the disclosure is mounted at a mounting position, for instance, on a wall, a ceiling or other structural members; a position of the light source 20 is adjusted through rotation according to light needs; and in order to avoid the situation that the light is directly emitted to a user when being directly emitted to the bottom light outlet 102, and alternatively, glare is caused by the light directly emitted from the bottom light outlet 102, the light output direction of the light source 20 of the disclosure and an opening direction of the bottom light outlet 102 are arranged with an included angle therebetween. “Not directly irradiate” indicates that the included angle between the light output direction of the light source 20 and the opening direction of the bottom light outlet 102 is 90°-270° instead of 90° and 270°.

Certainly, the light source 20 may also be set to rotate by 360° for some light needs.

For further explanation for the above description, “not directly irradiate” in the disclosure indicates that the light emitted from the light source 20 is reflected by any reflector in the reflective cavity 103 and then emitted from the top light outlet 101 and the bottom light outlet 102. Certainly, all light is reflected, and alternatively, part of light emitted from the light source 20 is not reflected and be directly emitted from the top light outlet 101 and the bottom light outlet 102, that is, part of light is directly emitted, which is not limited in practical application.

It is to be further noted that the light emitted from the top light outlet 101 is directly emitted, and the light directly emitted is reflected to achieve an illumination function when falling on a ceiling or a wall.

As shown in FIGS. 1-4, in a direction of the top light outlet 101 and the bottom light outlet 102, a distance between the light source 20 and the top light outlet 101 is greater than that between the light source 20 and the bottom light outlet 102.

Specifically, the light source 20 is arranged near the bottom light outlet 102, and the light source 20 is rotatably arranged, such that the light emitting direction of the light source 20 is adjustable. Light in a main light emitting direction of the light source 20 is emitted directly or emitted from the top light outlet 101 after reflected, and part of the light is emitted from the bottom light outlet 102 through reflection. The light source 20 is rotated, such that main light emitted from the top light outlet 101 and main light emitted from the bottom light outlet 102 is adjustable while the luminous flux of the top light outlet 101 and the bottom light outlet 102 is adjustable.

In an embodiment mode, the distance between the light source 20 and the top light outlet 101 is greater than that between the light source 20 and the bottom light outlet 102, and alternatively, a distance between the light source 20 and the top light outlet 101 is smaller than that between the light source 20 and the bottom light outlet 102, which is not limited herein. In this case, light in the main light emitting direction of the light source 20 is still emitted from the top light outlet 101.

In the present embodiment, the light source 20 is rotatably arranged, such that when the number of the light source 20 is one, distances between the light source 20 and the two reflective plates 110 is equal or not. The light emitting direction of the light source 20 is adjustable, such that irradiation zones of the top light outlet 101 and the bottom light outlet 102 is adjustable.

In an embodiment mode, the light source 20 is adjusted, such that the irradiation zones of the top light outlet 101 and the bottom light outlet 102 are switched between a symmetric state and an asymmetric state. When the light source 20 emits light toward the reflective surface of one reflective plate 110, the irradiation zones of the top light outlet 101 and the bottom light outlet 102 are asymmetric. That is, the light emitted from the top light outlet 101 and the bottom light outlet 102 is uneven, and most of the light is emitted to one reflective plate 110. A specific deflection direction is adjusted by adjusting a height of the reflective plates 110 and an orientation of the light source 20. In the present embodiment, the light source 20 is rotatably arranged, such that when the number of the light sources 20 is multiple and the light sources are arranged corresponding to the different reflective plates 110, heat dissipation gaps 1031 are formed between the light sources 20 and the adjacent reflective plates 110, and further heat dissipation efficiency of the light source 20 is improved.

The plurality of light sources 20 are set to have an equal height, such that the luminous flux of the top light outlet 101 and the bottom light outlet 102 is adjustable advantageously. Certainly, the plurality of light sources 20 may also have unequal heights.

As shown in FIGS. 1-4, the lamp body 10 further includes end covers 120 arranged oppositely. The reflective plates 110 are fixedly mounted on the end covers 120. The reflective plates 110 and the end covers 120 match each other to define the reflective cavity 103. The end covers 120 are configured to be connected to mounting positions.

The light source 20 is rotatably arranged on the end covers 120, such that the light source 20 is rotated and adjusted between the two reflective plates 110.

Specifically, the fixed end covers 120 and the reflective plates 110 define the reflective cavity 103, the reflective plates 110 are configured to reflect the light, and the end covers 120 are configured to shield light and provide mounting positions for the reflective plates 110.

In an embodiment mode, the two reflective plates 110 are arranged in parallel, and alternatively, the two reflective plates 110 are arranged in a trumpet-shaped structure, such that one of the top light outlet 101 and the bottom light outlet 102 is larger than the other light outlet.

In an embodiment mode, the reflective plates 110 are perpendicular to mounting positions, such that the light output direction of the top light outlet 101 is oriented toward the mounting positions, the light is reflected at the mounting positions, and further an illumination effect is improved. The bottom light outlet 102 faces away from the mounting positions.

In an embodiment mode, the reflective plates 110 are perpendicular to the end covers 120, such that mounting stability of the reflective plates 110 and the end covers 120 is improved.

In the present embodiment, the end covers 120 and mounting positions are connected by means of flexible connectors such as lifting ropes 50 and chains, or rigid connectors such as connection columns and connection rods, or are attached by means of suckers.

As shown in FIGS. 1-4, the light source 20 is rotatably connected to the end covers 120 of the lamp body 10 by means of one group of transmission assemblies 40.

Specifically, the transmission assembly 40 includes at least one group of movable members, and the movable members are rotatably connected to the end covers 120. The light source 20 is mounted on the movable members, and the light source 20 is rotatably connected to the end covers 120 by means of the movable members.

Each group of movable members includes two movable members arranged in a pair, and the two movable members are movably connected to the two end covers 120, respectively. Alternatively, each group of movable members is an integrated movable member. The light source 20 is mounted on the integrated movable member, and two ends of the integrated movable member are movably connected to the two end covers 120, respectively.

It should be noted that the two movable members arranged in a pair refer to two components arranged on two sides of the light source 20 facing the two end covers 120.

In the present embodiment, the movable members are movable shafts, and the light source 20 is rotatably connected to the end covers 120 by means of the movable shafts.

In an embodiment mode, the end covers 120 are provided with mounting holes. An inner wall surface of the mounting hole is provided with a plurality of groove structures. An outer peripheral surface of the end of the movable member is provided with at least one protrusion. The protrusion matches the groove structures in a clamped manner. During rotation of the movable member, the protrusion matches the different groove structures in a clamped manner, such that the movable member is switched between different positions.

Certainly, rotation may be achieved by engaging the protrusion with the groove structures, which is not limited herein. Alternatively, in the present embodiment, the end covers 120 is provided with a light source fixing shaft, the light source fixing shaft may extend toward or away from the reflective cavity 103, and the movable member rotatably matches the light source fixing shaft, such that the light source 20 may rotate around the light source fixing shaft by means of the movable member, and further the light source 20 is rotated and adjusted. One end of the movable member is connected to the light source 20, and the other end of the movable member is bent and rotatably sleeves the light source fixing shaft.

In the present embodiment, the light source 20 is rotated and adjusted manually or by means of a driving member 410. Specifically, the transmission assembly 40 further includes driving members 410. The driving members 410 are mounted on the end covers 120. The driving members 410 are in driving connection with the movable members. The driving member 410 is an electric motor, an air cylinder, or another driving structure.

In an embodiment mode, the surfaces facing each other of the two reflective plates 110 are the reflective surfaces. The reflective surfaces are straight and flat surfaces or curved surfaces. When the reflective surface is a straight and flat surface, the reflective surface is an entire straight and flat surface or is formed by sequentially connecting a plurality of angled straight and flat surfaces in the direction of the top light outlet 101 and the bottom light outlet 102. When the reflective surface is a curved surface, the light is reflected by a curved surface having preset curvature, such that light reflection efficiency is improved. The curved surface is an outer surface of a structure protruding from the reflective surface or an inner surface of a groove structure provided on the reflective surface.

The reflective plates 110 of the present embodiment are made of a non-transparent reflective material, which is not limited herein. Alternatively, the reflective plates 110 are made of a semitransparent material or a transparent material if necessary, such that part of light may pass the reflective plates 110 and be emitted from sides while the reflective plates 110 may reflect light. For instance, the reflective plate is a prism structure achieving both reflection and refraction.

In an embodiment mode, in order to improve reflection efficiency, the reflective surfaces are covered with reflective films or reflective paint or reflective powder.

In the present embodiment, the light source 20 is a linear light source, and the entire lamp is a long-strip lamp structure.

In the present embodiment, end surfaces away from each other of the two reflective plates 110 are flat surfaces or curved surface. The end surfaces away from each other of the two reflective plates 110 are adaptively set according to aesthetic needs of different people for the lamp body 10. In the present embodiment, as shown in FIGS. 1-4, surfaces away from each other of the two reflective plates 110 arranged in a pair are curved surfaces.

It should be noted that when the surfaces away from each other of the two reflective plates 110 arranged in a pair are the curved surfaces, curvature of the curved surfaces is adaptively set as required.

In the present embodiment, the lamp further includes a power supply. The power supply is mounted at a mounting position. The power supply is electrically connected to the light source 20. The power supply is not mounted in the lamp body 10 and the reflective cavity 103, such that the power supply is prevented from shielding light. In addition, the power supply is mounted without machining the lamp body 10, which is convenient in operation.

It should be noted that the movable connection manner described in the disclosure includes two types of rotation connection and removable connection.

### Embodiment 2

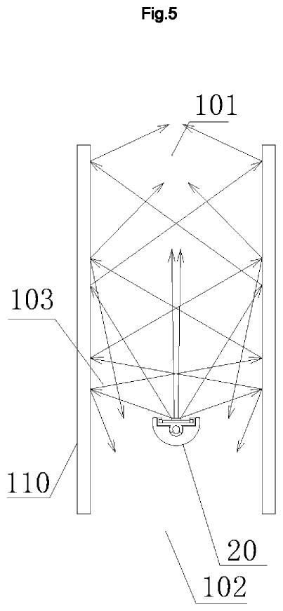

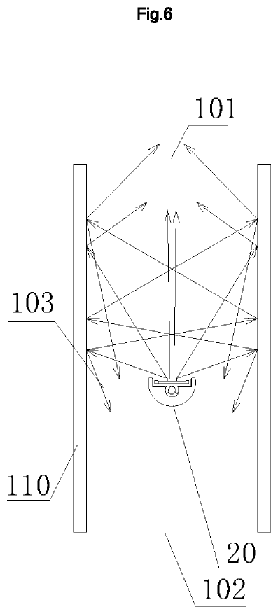

The present embodiment is different from embodiment 1 in that as shown in FIGS. 5-6, a light source 20 is removably arranged on end covers 120 in a direction of a top light outlet 101 and a bottom light outlet 102, and a position of the light source 20 is adjusted, such that a luminous flux of the top light outlet 101 and the bottom light outlet 102 is adjustable.

Specifically, the lamp further includes two groups of transmission assemblies 40. The light source 20 is removably connected to the end covers 120 of a lamp body 10 by means of one group of transmission assemblies 40.

In an embodiment mode, the transmission assembly 40 includes at least one movable member. The movable member is movably connected to the end covers 120. The light source 20 is mounted on the movable member. The light source 20 is removably connected to the end covers 120 by means of the movable member.

In a specific embodiment of the present embodiment, the end covers 120 are provided with slots 1201, the slots 1201 extend in a direction of the top light outlet 101 and the bottom light outlet 102, and at least part of the movable member extends into the slot 1201 and is removable in an extension direction of the slot 1201, such that the light source 20 may move in the slot 1201, a light output direction of the light source 20 is adjustable, and further the luminous flux between the top light outlet 101 and the bottom light outlet 102 is adjustable.

In another specific embodiment of the present embodiment, the end covers 120 are provided with slots 1201, the slots 1201 extend in a direction in which the two reflective plates 110 face each other, and at least part of the movable member extends into the slot 1201 and is removable in an extension direction of the slot 1201, such that the light source 20 may move in the slot 1201, a light output direction of the light source 20 is adjustable, and further the luminous flux between the top light outlet 101 and the bottom light outlet 102 is adjustable.

In yet another specific embodiment of the present embodiment, the end covers 120 are provided with slots 1201, the slots 1201 extend in a direction with an angle formed between which and a direction in which the two reflective plates 110 face each other, and at least part of the movable member extends into the slot 1201 and is removable in an extension direction of the slot 1201, such that the light source 20 may move in the slot 1201, a light output direction of the light source 20 is adjustable, and further the luminous flux between the top light outlet 101 and the bottom light outlet 102 is adjustable.

It should be noted that when the number of the slot 1201 is one in the present embodiment, the slot 1201 is the slot 1201 in one of the present embodiments. When the number of the slots 1201 is two, the two slots 1201 are in communication with each other, and the two slots 1201 are any two slots in the three embodiments. When the number of the slots 1201 is three, the slots 1201 include the slots 1201 in communication with one another in the above three embodiments.

In an embodiment mode, the transmission assembly 40 further includes moving members 420 and driving members 410. At least part of an end of the movable member penetrates the slot 1201 so as to be connected to the moving member 420. The moving member 420 is located on an outer side of a reflective cavity 103. The driving members 410 are mounted on the end covers 120. The driving members 410 are in driving connection with the moving members 420.

The moving members 420 are racks. The driving members 410 are electric motors. Output ends of the electric motors are provided with gears. The gears mesh with the racks. The driving members 410 drive the racks to move in the direction of the top light outlet 101 and the bottom light outlet 102, and further drive the movable member to move in the direction of the top light outlet 101 and the bottom light outlet 102.

It should be noted that the driving members 410 are the electric motors or other structural members, which is not limited herein. Alternatively, the moving members 420 are racks, and the driving members 410 are handle assemblies 60. The handle assemblies 60 include gears and rotary discs. The gears are rotatably mounted on the end covers 120 and mesh with the racks. The rotary discs are fixedly connected to the gears. The rotary discs are in driving connection with the racks by means of the gears.

### Embodiment 3

The present embodiment is different from Embodiment 1 and Embodiment 2 in that a light source 20 rotates by means of a transmission assembly 40 and is removably arranged on end covers 120.

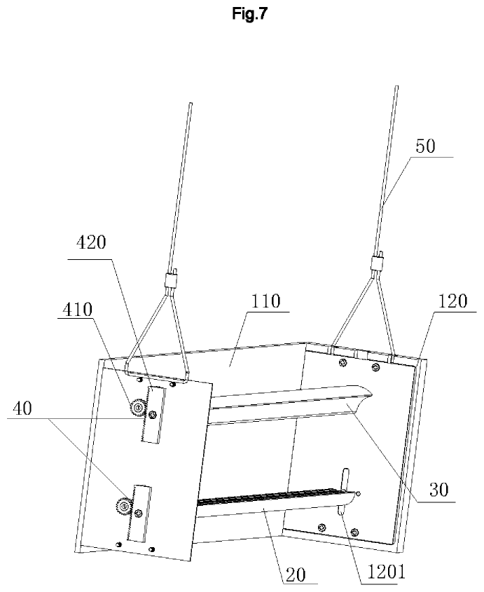

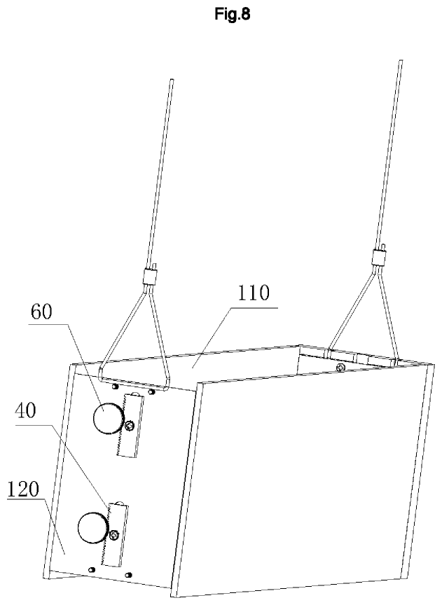

As shown in FIGS. 7-8, the transmission assembly 40 includes a movable member. The light source 20 is mounted on the movable member. The end covers 120 are provided with slots 1201. The movable member is arranged corresponding to the slot 1201.

Specifically, the transmission assembly 40 further includes moving members 420 and driving members 410. At least part of an end of the movable member penetrates the slot 1201 so as to be connected to the moving member 420. The moving member 420 is located on an outer side of a reflective cavity 103. The driving members 410 are mounted on the end covers 120. The driving members 410 are in driving connection with the moving members 420.

The end of the movable member is rotatably connected to the moving member 420. The moving member 420 is provided with a mounting hole. An inner wall surface of the mounting hole is provided with a plurality of groove structures. An outer peripheral surface of the end of the movable member is provided with at least one protrusion. The protrusion the groove structures in a clamped manner. During rotation of the movable member, the protrusion matches the different groove structures in a clamped manner, such that the movable member is switched between different positions.

In the present embodiment, the moving members 420 are racks. The driving members 410 are electric motors. Output ends of the electric motors are provided with gears. The gears mesh with the racks. The driving members 410 provide a driving force for vertical movement of the moving members 420. The light source 20 is rotated and adjusted manually.

It should be noted that the driving members 410 are the electric motors or other structural members, which is not limited herein. Alternatively, the moving members 420 are racks, and the driving members 410 are handle assemblies 60. The handle assemblies 60 include gears and rotary discs. The gears are rotatably mounted on the end covers 120 and mesh with the racks. The rotary discs are fixedly connected to the gears. The rotary discs are in driving connection with the racks by means of the gears.

The present embodiment is different from Embodiment 3 in that a light source 20 is removable adjusted without an engagement means. In the present embodiment, moving members 420 are removable adjusted manually.

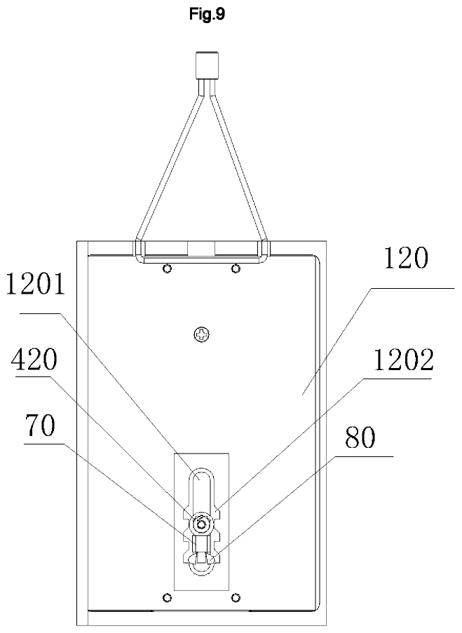

As shown in FIG. 9, a transmission assembly 40 includes a movable member. The light source 20 is mounted on the movable member. End covers 120 are provided with slots 1201. One group of opposite inner wall surfaces of the slot 1201 are provided with a plurality of groups of clamping grooves 1202 corresponding to each other in position. The clamping grooves 1202 are in communication with the slots 1201. The plurality of groups of clamping grooves 1202 are provided at intervals in an extension direction of the slot 1201.

In the plurality of groups of clamping grooves 1202, a distance between two adjacent groups of clamping grooves 1202 is adaptively set as required.

In an embodiment mode, the transmission assembly 40 further includes the moving members 420 and sleeves 70. At least part of an end of the movable member penetrates the slot 1201 so as to be connected to the moving member 420. The moving member 420 is located on an outer side of a reflective cavity 103. The moving members 420 are connected to the sleeves 70. Bottom surfaces of the sleeves 70 are provided with elastic clamping arms 80.

When the elastic clamping arm 80 is accommodated in the slot 1201, the sleeve 70 and the moving member 420 are both located in the slot 1201, such that the sleeve 70 and the moving member 420 are manually driven to move in an extension direction of the slot 1201, and further a position of the light source 20 is adjustable.

When at least part of the elastic clamping arm 80 extends into the clamping groove 1202, the elastic clamping arm 80 matches the clamping groove 1202 in a clamped manner so as to be limited. In this case, the moving member 420 and the sleeve 70 are stably mounted on the end cover 120.

In the present embodiment, the elastic clamping arm 80 includes a first elastic arm and a second elastic arm that are arranged in a pair. First ends of the two elastic arms are movably connected to the sleeve 70, and second ends of the elastic arms extend out of the sleeve 70. The elastic clamping arm 80 further includes an elastic structural member arranged between the first elastic arm and the second elastic arm. The elastic structural member provides a driving force for the second ends of the first elastic arm and the second elastic arm to move away from each other. Under the driving action of the elastic structural member, the second ends of the first elastic arm and the second elastic arm are of a trumpet-shaped structure, and the second ends of the first elastic arm and the second elastic arm extend into the clamping grooves 1202 oppositely provided, respectively.

When the light source 20 needs to be removable adjusted, an external force is manually applied to the second ends of the first elastic arm and the second elastic arm, such that an elastic force of the elastic structural member is overcome. Further, the first elastic arm and the second elastic arm are accommodated in the slot 1201. Further, the sleeve 70 and the moving member 420 may move to preset positions, and then the first elastic arm and the second elastic arm are released. Under an elastic force of the elastic structural member, the second ends of the first elastic arm and the second elastic arm enter the clamping groove 1202 again so as to be positioned.

In the present embodiment, the movable member is rotatably arranged on the moving member 420. Specifically, the end of the movable member is rotatably connected to the moving member 420. The moving member 420 is provided with a mounting hole. An inner wall surface of the mounting hole is provided with a plurality of groove structures. An outer peripheral surface of the end of the movable member is provided with at least one protrusion. The protrusion matches the groove structures in a clamped manner.

### Embodiment 5

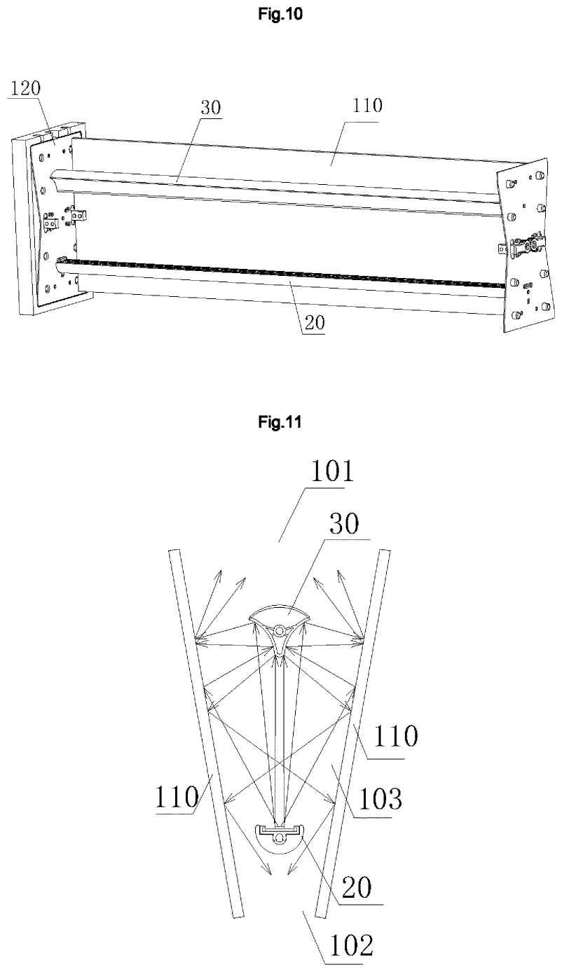

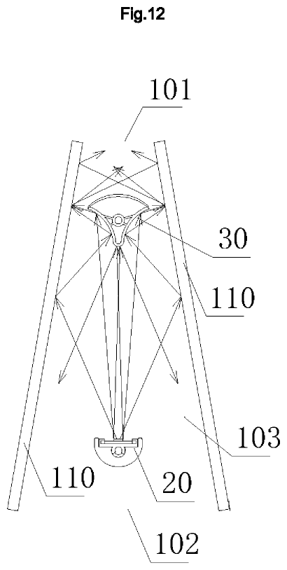

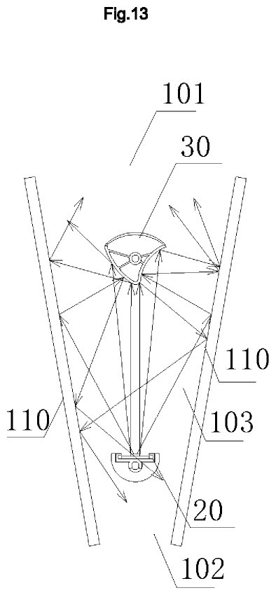

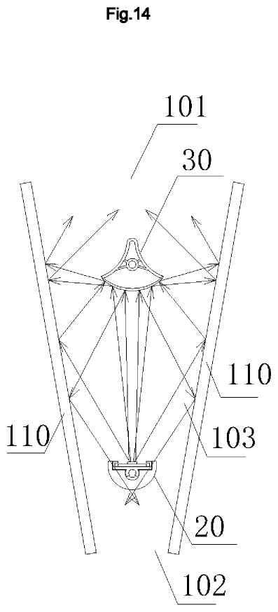

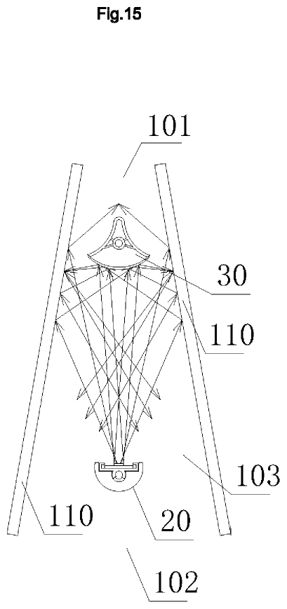

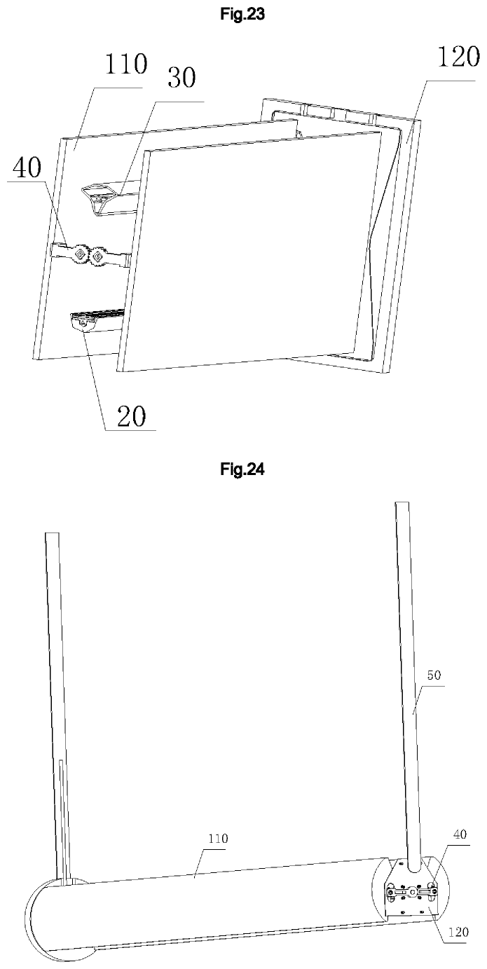

The present embodiment is different from Embodiment 1 in that as shown in FIGS. 10-15 and 23-24, a reflective structure includes reflective plates 110 arranged in a pair, and the reflective plates 110 are rotatably arranged on end covers 120.

Specifically, the reflective plates 110 are rotatably connected to the end covers 120, such that a space size and a luminous flux between a top light outlet 101 and a bottom light outlet 102 between the reflective plates 110 are adjustable.

In an embodiment mode, a transmission assembly 40 includes at least two groups of movable members. The two reflective plates 110 are mounted on the two groups of movable members, respectively. The two reflective plates 110 are rotatably connected to the end covers 120 by means of the two groups of movable members.

Each group of movable members includes two movable members arranged in a pair, and the two movable members are movably connected to the two end covers 120, respectively. Alternatively, each group of movable members is an integrated movable member. The two reflective plates 110 are mounted on the two integrated movable members, respectively. Two ends of each integrated movable member are rotatably connected to the end covers 120.

In the present embodiment, the movable members are movable shafts, and the reflective plates 110 are rotatably connected to the end covers 120 by means of the movable shafts.

It should be noted that the two movable members arranged in a pair refer to two components arranged on two sides of the reflective plate 110 facing the two end covers 120.

In the present embodiment, each end cover 120 is provided with one or two fixing shafts. The fixing shafts may extend toward a reflective cavity 103, or may extend away from a reflective cavity 103.

When the number of the fixing shaft is one, a first end of the movable member located at the same side of the reflective plate 110 in the two groups of movable members is connected to the reflective plate, and a second end of the movable member is bent and then rotatably sleeves the fixing shaft, such that the reflective plates 110 are rotatably connected to the end covers 120. The second ends of the two movable members sleeve the same fixing shaft, and the second ends of the two movable members abut against each other in an extension direction of the fixing shaft.

In an embodiment mode, the second ends of the two movable members are rotatably connected by means of a rotating mechanism, such that the two movable members are linked by means of the rotating mechanism, and further the two reflective plates 110 is linked by means of the two movable members. Specifically, the rotating mechanism is a pawl structure. That is, one of the movable members is provided with ratchet teeth, and the other movable member is provided with ratchet grooves, such that rotating fit may achieved through a matching structure of the ratchet teeth and ratchet wheels.

When the number of the fixing shafts is two, two movable members located at the same side of the reflective plate 110 in the two groups of movable members are arranged in one-to-one correspondence with the two fixing shafts on the end cover. A first end of the movable member is connected to the reflective plate, and a second end of the movable member is bent and then rotatably sleeves the fixing shaft, such that the reflective plates 110 are rotatably connected to the end covers 120.

In an embodiment mode, second ends of the two movable members sleeve different fixing shafts, and the second ends of the two movable members are rotatably connected to each other. Specifically, the second ends of the two movable members are both provided with gears, and the second ends of the two movable members are rotatably connected through gear meshing.

### Embodiment 6

The present embodiment is different from Embodiment 1 in that a reflective structure includes reflective plates 110 arranged in a pair, and the reflective plates 110 are removably arranged on end covers 120.

Specifically, the end cover 120 is provided with one or more slots 1201, and a light source 20 is removably connected to the end cover 120 by means of a rotating shaft. The reflective plates 110 are removably connected to the end covers 120, such that a luminous flux between a top light outlet 101 and a bottom light outlet 102 between the two reflective plates 110 is adjustable.

In an embodiment mode, according to different extension directions of the slots 1201, the reflective plates 110 may move in different directions.

In a specific embodiment, when the slots 1201 extend in a direction of the top light outlet 101 and the bottom light outlet 102, the reflective plates 110 may move in the extension direction of the slots 1201. Further, positions of the two reflective plates 110 in the direction of the top light outlet 101 and the bottom light outlet 102 are adjustable. Further, the luminous flux between the top light outlet 101 and the bottom light outlet 102 is adjustable.

In a specific embodiment, when the slots 1201 extend in a direction in which the two reflective plates 110 oppositely arranged face each other, the reflective plates 110 may move close to or away from each other on the end covers 120. Further, a space size between the top light outlet 101 and the bottom light outlet 102 between the two reflective plates 110 is adjustable. Further, the luminous flux between the top light outlet 101 and the bottom light outlet 102 is adjustable.

In a specific embodiment, the slots 1201 extend in a direction with an angle formed between which and the direction in which the two reflective plates 110 face each other, such that the two reflective plates 110 are aligned or staggered. Specifically, the reflective plates 110 are moved in the direction with an angle formed between which and the direction in which the two reflective plates 110 face each other, such that the two reflective plates 110 may move away from each other and be staggered at the same time. At the same time, the two reflective plates 110 move away from each other and the two reflective plates 110 are staggered, and further the luminous flux of the top light outlet 101 and the bottom light outlet 102 is adjustable.

It should be noted that when the number of the slot 1201 is one in the present embodiment, the slot 1201 is the slot 1201 in one of the present embodiments. When the number of the slots 1201 is two, the two slots 1201 are in communication with each other, and the two slots 1201 is any two slots in the three embodiments. When the number of the slots 1201 is three, the slots 1201 include the slots 1201 in communication with one another in the above three embodiments.

### Embodiment 7

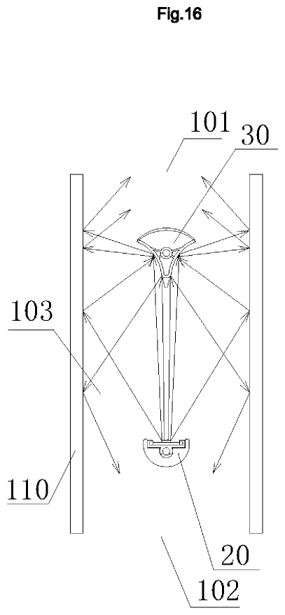

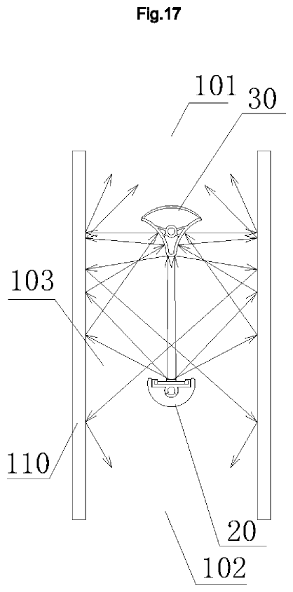

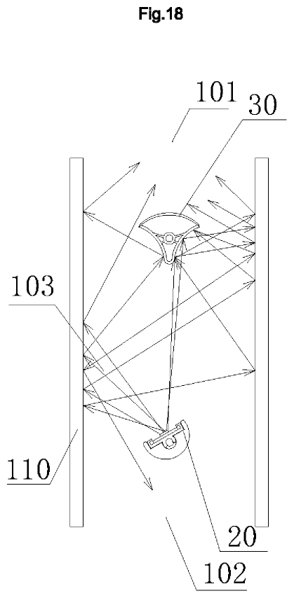

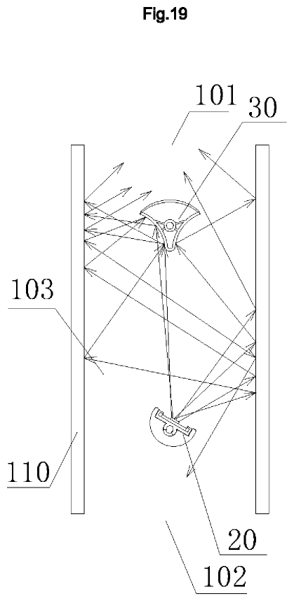

The present embodiment is different from Embodiment 1 in that as shown in FIGS. 16-20, a reflective structure further includes a reflective cover 30 movably arranged in a reflective cavity 103, a light output end of a light source 20 faces the reflective cover 30, and at least a surface facing the light source 20 of the reflective cover 30 is a light reflecting surface.

Specifically, the light reflecting surface is configured to reflect light of the light source 20, such that a luminous flux of a top light outlet 101 and a bottom light outlet 102 is adjustable.

In an embodiment mode, an outer surface of the reflective cover 30 is formed by sequentially connecting a plurality of light reflecting surfaces. The light reflecting surfaces facing the light source 20 are configured to guide light in the reflective cavity 103 to the top light outlet 101 and the bottom light outlet 102.

Shapes of the light reflecting surfaces are adaptively set as required. At least one end surface of the light reflecting surfaces is a flat surface, and alternatively, at least one end surface of the light reflecting surfaces is an arc-shaped surface.

In the present embodiment, when all the light reflecting surfaces are arc-shaped surfaces, the outer surface of the reflective cover 30 includes a first arc-shaped section 310, a second arc-shaped section 320 and a third arc-shaped section 330 that are sequentially connected end to end. Two of the first arc-shaped section 310, the second arc-shaped section 320 and the third arc-shaped section 330 are concave arcs, and the other arc-shaped section is a convex arc;

In an embodiment mode, the outer surface of the reflective cover 30 is of a symmetric structure, and the two concave arcs are arranged symmetrically with respect to the convex arc.

In an embodiment mode, the outer surface of the reflective cover 30 is of the symmetric structure, which is not limited herein. Alternatively, the outer surface of the reflective cover 30 is of an asymmetric structure. In this case, the two concave arcs have different radii of curvature.

In the present embodiment, in a direction of the top light outlet 101 and the bottom light outlet 102, the reflective cover 30 is located between the light source 20 and the top light outlet 101, and alternatively, the reflective cover 30 is located between the light source 20 and the bottom light outlet 102. A set position of the reflective cover 30 is set adaptively according to a main light emitting direction of the light source 20, such that main light of the light source 20 is emitted to the light reflecting surfaces.

When the main light emitting direction of the light source 20 is oriented toward the bottom light outlet 102, the reflective cover 30 is arranged in a zone between the light source 20 and the bottom light outlet 102, such that light emitted from the light source 20 to the light reflecting surfaces of the reflective cover 30 is reflected. When the main light emitting direction of the light source 20 is oriented toward the top light outlet 101, the reflective cover 30 is located between the light source 20 and the top light outlet 101, such that light emitted from the light source 20 to the light reflecting surfaces of the reflective cover 30 is reflected.

In the present embodiment, the reflective cover 30 is rotatably connected to end covers 120 of a lamp body 10 by means of one group of transmission assemblies 40.

Specifically, the transmission assembly 40 includes at least one group of movable members, and the movable members are rotatably connected to the end covers 120. The reflective cover 30 is mounted on the movable members, and the reflective cover 30 is rotatably connected to the end covers 120 by means of the movable members.

Each group of movable members includes two movable members arranged in a pair, and the two movable members are movably connected to the two end covers 120, respectively. Alternatively, each group of movable members is an integrated movable member. The reflective cover 30 is mounted on the integrated movable member, and two ends of the integrated movable member are movably connected to the two end covers 120, respectively.

In the present embodiment, the movable members are movable shafts, and the reflective cover 30 is rotatably connected to the end covers 120 by means of the movable shafts.

It should be noted that the two movable members arranged in a pair refer to two components arranged on two sides of the reflective cover 30 facing the two end covers 120.

In an embodiment mode, the end covers 120 are provided with mounting holes. An inner wall surface of the mounting hole is provided with a plurality of groove structures. An outer peripheral surface of the end of the movable member is provided with at least one protrusion. The protrusion matches the groove structures in a clamped manner. During rotation of the movable member, the protrusion matches the different groove structures in a clamped manner, such that the movable member is switched between different positions.

Certainly, rotation is achieved by engaging the protrusion with the groove structures, which is not limited herein. Alternatively, in the present embodiment, the end covers 120 are provided with a light source fixing shaft, the light source fixing shaft may extend toward or away from the reflective cavity 103, and the movable member rotatably matches the fixing shaft, such that the reflective cover 30 may rotate around the fixing shaft by means of the movable member, and further the reflective cover 30 is rotated and adjusted. One end of the movable member is connected to the reflective cover 30, and the other end of the movable member is bent and rotatably sleeves the fixing shaft.

### Embodiment 8

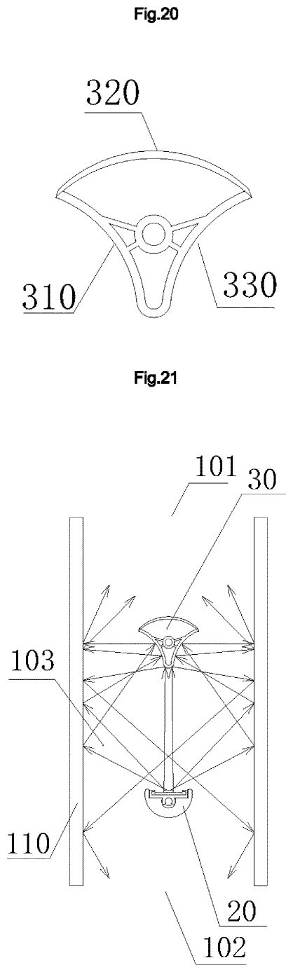

The present embodiment is different from Embodiment 7 in that as shown in FIG. 21, a reflective cover 30 is removably arranged on end covers 120 of a lamp body 10.

Specifically, the reflective cover 30 is removably connected to the end covers 120 of the lamp body 10 by means of a transmission assembly 40.

In an embodiment mode, the transmission assembly 40 includes a movable member removably connected to the end covers 120, and the reflective cover 30 is mounted on the movable member.

In an embodiment mode, the transmission assembly 40 includes at least one movable member. The movable member is movably connected to the end covers 120. A light source 20 is mounted on the movable member. The light source 20 is removably connected to the end covers 120 by means of the movable member.

In a specific embodiment of the present embodiment, the end covers 120 are provided with slots 1201, the slots 1201 extend in a direction of a top light outlet 101 and a bottom light outlet 102, and at least part of the movable member extends into the slot 1201 and is removable in an extension direction of the slot 1201, such that the reflective cover 30 may move in the slot 1201, a light output direction and a position of the reflective cover 30 are adjustable, and further a luminous flux between the top light outlet 101 and the bottom light outlet 102 is adjustable.

In another specific embodiment of the present embodiment, the end covers 120 are provided with slots 1201, the slots 1201 extend in a direction in which two reflective plates 110 face each other, and at least part of the movable member extends into the slot 1201 and is removable in an extension direction of the slot 1201, such that the reflective cover 30 may move in the slot 1201, a light output direction and a position of the reflective cover 30 are adjustable, and further a luminous flux between the top light outlet 101 and the bottom light outlet 102 is adjustable.

In yet another specific embodiment of the present embodiment, the end covers 120 are provided with slots 1201, the slots 1201 extend in a direction with an angle formed between which and a direction in which two reflective plates 110 face each other, and at least part of the movable member extends into the slot 1201 and is removable in an extension direction of the slot 1201, such that the reflective cover 30 may move in the slot 1201, a light output direction and a position of the reflective cover 30 are adjustable, and further a luminous flux between the top light outlet 101 and the bottom light outlet 102 is adjustable.

It should be noted that when the number of the slot 1201 is one in the present embodiment, the slot 1201 is the slot 1201 in one of the present embodiments. When the number of the slots 1201 is two, the two slots 1201 are in communication with each other, and the two slots 1201 is any two slots in the three embodiments. When the number of the slots 1201 is three, the slots 1201 include the slots 1201 in communication with one another in the above three embodiments.

In the present embodiment, the end covers 120 are provided with the slots 1201 extending from the top light outlet 101 to the bottom light outlet 102. The movable member is arranged corresponding to the slot 1201.

Further, the transmission assembly 40 further includes moving members 420 and driving members 410. At least part of an end of the movable member penetrates the slot 1201 so as to be connected to the moving member 420. The moving member 420 is located on an outer side of the reflective cavity 103. The driving members 410 are mounted on the end covers 120. The driving members 410 are in driving connection with the moving members 420. The driving members 410 provide a driving force for the moving members 420 to move from the top light outlet 101 to the bottom light outlet 102.

The reflective cover 30 is adjusted manually or automatically. When the reflective cover is adjusted manually, the moving members 420 are racks, the driving members 410 are handle assemblies 60, the handle assemblies 60 include gears and rotary discs, the gears are rotatably mounted on the end covers 120 and mesh with the racks, the rotary discs are fixedly connected to the gears, and the rotary discs are in driving connection with the racks by means of the gears. When the reflective cover is adjusted automatically, the moving members 420 are racks, the driving members 410 are electric motors, output ends of the electric motors are provided with gears, and the gears mesh with the racks.

### Embodiment 9

The present embodiment is different from Embodiment 8 in that a reflective cover 30 is removably and rotatably arranged on end covers 120 of a lamp body 10.

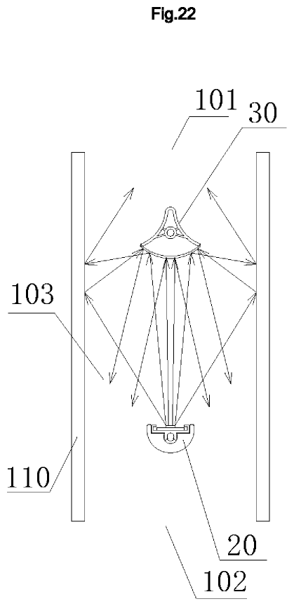

As shown in FIG. 22, an end of a movable member is rotatably connected to a moving member 420. The moving member 420 is provided with a mounting hole. An inner wall surface of the mounting hole is provided with a plurality of groove structures. An outer peripheral surface of the end of the movable member is provided with at least one protrusion. The protrusion matches the groove structures in a clamped manner. During rotation of the movable member, the protrusion matches the different groove structures in a clamped manner, such that the movable member is switched between different positions.

### Embodiment 10

The present embodiment is different from Embodiment 1 in that a light output direction of a light source 20 and an opening direction of a top light outlet 101 are arranged with an included angle therebetween, such that the light source 20 does not directly irradiate the top light outlet 101.

Specifically, “not directly irradiate” in the disclosure indicates that light emitted from the light source 20 is reflected by any reflector in a reflective cavity 103 and then emitted from the top light outlet 101 and a bottom light outlet 102. Certainly, all light is reflected, or, part of light emitted from the light source 20 is not reflected and be directly emitted from the top light outlet 101 and the bottom light outlet 102, that is, part of light is directly emitted, which is not limited in practical application.

It is further noted that when a space below the bottom light outlet 102 is a non-human activity space, or has no function of a human activity space, the light of the light source 20 is emitted directly from the bottom light outlet 102, and the light directly emitted is reflected to achieve an illumination function when falling on a floor or a wall.

In the present embodiment, a main light emitting direction of a light outlet of the light source faces away from the top light outlet 101.

From the above description, it is seen that the above embodiments of the disclosure achieve the following technical effects:
The reflective structure of the lamp of the disclosure is provided with double light outlets including the top light outlet 101 and the bottom light outlet 102, such that the light output direction is increased. In addition, at least one of the light source 20 and the reflective structure of the disclosure is movably arranged, such that a light output path of the light is adjusted by adjusting the light source 20 and the reflective structure. Further, the luminous flux of the top light outlet 101 and the bottom light outlet 102 is adjustable, such that output light is adjusted according to needs of use scenarios, and user experience is improved.

Obviously, the present embodiments described above are merely some embodiments rather than all embodiments of the disclosure. Based on the present embodiments of the disclosure, all other embodiments obtained by those of ordinary skill in the art without making creative efforts should fall within the scope of protection of the disclosure.

It should be noted that the terms used herein are merely for describing the detailed description of embodiments and are not intended to limit illustrative embodiments according to the disclosure. As used herein, the singular is also intended to include the plural unless the context clearly points out the singular or plural. In addition, it should be understood that terms “include” and/or “comprise” used in the description indicate the presence of features, steps, operations, devices, assemblies, and/or their combinations.

It should be noted that the terms “first”, “second”, etc., in the description and claims of the disclosure and in the drawings, are used to distinguish between similar objects and not necessarily to describe a particular order or sequential order. It should be understood that data used in this way can be interchanged where appropriate, such that the present embodiments of the disclosure described herein can be implemented in other orders than those illustrated or described herein.

What are described above are merely the preferred embodiments of the disclosure and are not intended to limit the disclosure, and various changes and modifications can be made by those skilled in the art. Any modifications, equivalent substitutions, improvements, etc. made within the spirit and principle of the disclosure should fall within the scope of protection of the disclosure.

What is claimed is:

1. A lamp, comprising:
a lamp body, wherein the lamp body is provided with a reflective structure, the reflective structure is provided with a reflective cavity, and two ends of the reflective cavity are provided with a top light outlet and a bottom light outlet respectively; and
a light source, wherein the light source is arranged in the reflective cavity and spaced from an inner wall of the reflective structure, and at least part of light of the light source is emitted toward an inner wall surface of the reflective structure; and the inner wall surface of the reflective structure is configured to reflect the light, such that the light is emitted from the top light outlet and the bottom light outlet, and at least one of the light source and the reflective structure is movably arranged, such that a luminous flux of the top light outlet and the bottom light outlet is adjustable.

2. The lamp according to claim 1, wherein
a light output direction of the light source and an opening direction of the bottom light outlet are arranged with an included angle therebetween, such that the light source does not directly irradiate the bottom light outlet; or,
a light output direction of the light source and an opening direction of the top light outlet are arranged with an included angle therebetween, such that the light source does not directly irradiate the top light outlet.

3. The lamp according to claim 2, wherein
the included angle between the light output direction of the light source and the opening direction of the bottom light outlet is greater than 90° and smaller than 270°; and/or
light emitted from the bottom light outlet is reflected by the reflective structure and the reflective cavity and then emitted.

4. The lamp according to claim 1, wherein in a direction of the top light outlet and the bottom light outlet
a distance between the light source and the top light outlet is greater than that between the light source and the bottom light outlet; or,
a distance between the light source and the top light outlet is smaller than that between the light source and the bottom light outlet.

5. The lamp according to claim 1, wherein the reflective structure comprises two reflective plates arranged oppositely, and the reflective cavity is formed between the two reflective plates;
the number of the light source is one; or,
the number of the light sources is multiple, the light sources are arranged corresponding to the different reflective plates, and heat dissipation gaps are formed between the light sources and the adjacent reflective plates.

6. The lamp according to claim 1, wherein the reflective structure comprises two reflective plates arranged oppositely, surfaces facing each other of the two reflective plates are reflective surfaces, the light source is arranged between the two reflective plates and at least part of the light of the light source is emitted toward the reflective surfaces; and the lamp body further comprises:
end covers arranged oppositely, wherein the reflective plates are connected to the end covers the reflective plates and the end covers match each other to define the reflective cavity and the end covers are configured to be connected to a mounting position.

7. The lamp according to claim 6, wherein
the light source is removably and/or rotatably arranged on the end covers and/or
the reflective plates are removably and/or rotatably arranged on the end covers.

8. The lamp according to claim 1, wherein the reflective structure further comprises a reflective cover arranged in the reflective cavity a light output end of the light source faces the reflective cover, and at least a surface facing the light source of the reflective cover is a light reflecting surface;
in a direction of the top light outlet and the bottom light outlet, the reflective cover is located between the light source and the top light outlet or,
in a direction of the top light outlet and the bottom light outlet, the reflective cover is located between the light source and the bottom light outlet.

9. The lamp according to claim 8, wherein an outer surface of the reflective cover is formed by sequentially connecting a plurality of light reflecting surfaces, and the light reflecting surfaces facing the light source are configured to guide light in the reflective cavity to the reflective plates and/or the top light outlet and/or the bottom light outlet of the reflective structure.

10. The lamp according to claim 9, wherein
at least one end surface of the light reflecting surface is a flat surface; and/or
at least one end surface of the light reflecting surface is an arc-shaped surface.

11. The lamp according to claim 9, wherein the outer surface of the reflective cover comprises a first arc-shaped section, a second arc-shaped section and a third arc-shaped section that are sequentially connected end to end, two of the first arc-shaped section the second arc-shaped section and the third arc-shaped section are concave arcs, and the other arc-shaped section is a convex arc;
the two concave arcs are arranged symmetrically with respect to the convex arc; or,
the two concave arcs have different radii of curvature.

12. The lamp according to claim 8, wherein
the reflective cover is fixedly mounted on the end covers of the lamp body; or,
the reflective cover is removably and/or rotatably arranged on the end covers of the lamp body

13. The lamp according to claim 8, further comprising a transmission assembly, wherein
the light source is removably and/or rotatably connected to the end covers of the lamp body by means of the transmission assembly and/or
the reflective cover is removably and/or rotatably connected to the end covers of the lamp body by means of the transmission assembly; and/or
the reflective plates of the reflective structure are removably and/or rotatably connected to the end covers of the lamp body by means of the transmission assembly

14. The lamp according to claim 13, wherein
the transmission assembly comprises one group of movable members, the one group of the movable members comprises two movable members arranged in a pair or is an integrated movable member, the movable member is movably connected to the end covers and the light source or the reflective cover is mounted on the movable member; or,
the transmission assembly comprises two groups of movable members, each group of the movable members comprises two movable members arranged in a pair or is an integrated movable member, the movable members are movably connected to the end covers the light source is mounted on one group of the movable members, and the reflective cover is mounted on the other group of the movable members; or,
the transmission assembly comprises two groups of movable members, each group of the movable members comprises two movable members arranged in a pair or is an integrated movable member, each group of the movable members are connected to the two end covers separately, and the two reflective plates are mounted on the two groups of the movable members; or,
the transmission assembly comprises three groups of movable members, each group of the movable members comprises two movable members arranged in a pair or is an integrated movable member, each group of the movable members are movably connected to the end covers, the light source or the reflective cover is mounted on one group of the movable members, and the two reflective plates are mounted on the other two groups of the movable members, respectively; or,
the transmission assembly comprises four groups of movable members, each group of the movable members comprises two movable members arranged in a pair or is an integrated movable member, each group of the movable members are movably connected to the end covers the light source is mounted on one group of the movable members, the reflective cover is mounted on another group of the movable members, and the two reflective plates are mounted on the other two groups of the movable members, respectively.

15. The lamp according to claim 13, wherein the end covers of the lamp body are provided with slots, and at least part of the transmission assembly is removably arranged in the slots;
the slots extend in a direction in which the two reflective plates face each other; and/or
the slots extend in the direction of the top light outlet and the bottom light outlet; and/or
the slots extend in a direction with an angle formed between which and a direction in which the two reflective plates face each other.

16. The lamp according to claim 13, wherein the end covers of the lamp body are provided with slots, and at least part of the transmission assembly is removably arranged in the slots
the slots extend in a direction in which the two reflective plates face each other, such that the reflective cover and the light source are aligned or staggered in the direction of the top light outlet and the bottom light outlet; and/or
the slots extend in the direction of the top light outlet and the bottom light outlet, such that a distance between the reflective cover and the light source in the direction of the top light outlet and the bottom light outlet increases or decreases; and/or
the slots extend in a direction with an angle formed between which and a direction in which the two reflective plates face each other, such that the reflective cover and the light source are aligned or staggered in the direction of the top light outlet and the bottom light outlet, and/or a distance between the reflective cover and the light source in the direction of the top light outlet and the bottom light outlet increases or decreases.

17. The lamp according to claim 14, wherein the end covers of the lamp body are provided with slots and the transmission assembly further comprises:
moving members, wherein at least part of an end of the movable member penetrates the slot so as to be connected to the moving member, and
the moving member is located on an outer side of the reflective cavity and driving members wherein the driving members are mounted on the end covers, and the driving members are in driving connection with the moving members.

18. The lamp according to claim 17, wherein
the moving members are racks, the driving members are electric motors, output ends of the electric motors are provided with gears, and the gears mesh with the racks; or,
the moving members are racks, the driving members are handle assemblies the handle assemblies comprise gears and rotary discs, the gears are rotatably mounted on the end covers and mesh with the racks, the rotary discs are fixedly connected to the gears, and the rotary discs are in driving connection with the racks by means of the gears.

19. The lamp according to claim 14, wherein the end covers of the lamp body are provided with slots, one group of opposite inner wall surfaces of the slot are provided with a plurality of groups of clamping grooves corresponding to each other in position, the clamping grooves are in communication with the slots and the plurality of groups of clamping grooves are provided at intervals in an extension direction of the slot; and the transmission assembly further comprises:
moving members wherein at least part of an end of the movable member penetrates the slot so as to be connected to the moving member and the moving member is located on an outer side of the reflective cavity and
sleeves, wherein the moving members are connected to the sleeves, bottom surfaces of the sleeves are provided with elastic clamping arms the elastic clamping arms are accommodated in the slots or, at least part of the elastic clamping arm extends into the clamping groove.

20. The lamp according to claim 17, wherein the end of the movable member is rotatably connected to the moving member, the moving member is provided with a mounting hole, an inner wall surface of the mounting hole is provided with a plurality of groove structures, an outer peripheral surface of the end of the movable member is provided with at least one protrusion, and the protrusion matches the groove structure in a clamped manner.

21. The lamp according to claim 6, wherein
the surfaces facing each other of the two reflective plates arranged in a pair are flat surfaces or non-flat surfaces; and/or
surfaces away from each other of the two reflective plates arranged in a pair are flat surfaces or non-flat surfaces; and/or
the reflective plates-are made of a transparent material or a semitransparent material; and/or
the surfaces facing each other of the two reflective plates arranged in a pair are covered with reflective films or reflective paint or reflective powder.

22. The lamp according to claim 1, wherein
the light source is a linear light source; and/or
the lamp is a long-strip lamp; and/or
the lamp is a ceiling lamp.

23. The lamp according to claim 19, wherein the end of the movable member is rotatably connected to the moving member, the moving member is provided with a mounting hole, an inner wall surface of the mounting hole is provided with a plurality of groove structures, an outer peripheral surface of the end of the movable member is provided with at least one protrusion, and the protrusion matches the groove structure in a clamped manner.
